(19) United States
(12) Patent Application Publication
(10) Pub. No.: US 2024/0042866 A1
(43) Pub. Date: Feb. 8, 2024

(54) BOOM HEAD ASSEMBLY FOR AN ELECTRIC OR HYBRID VEHICLE

(71) Applicant: MULTIBUS LTD, Lincoln (GB)

(72) Inventor: Terence Patrick O'HALLORAN, Lincoln (GB)

(73) Assignee: MULTIBUS LTD, Lincoln (GB)

(21) Appl. No.: 18/043,598

(22) PCT Filed: Aug. 30, 2021
(86) PCT No.: PCT/AU2021/051005

§ 371 Date: Mar. 1, 2023

(30) Foreign Application Priority Data
Sep. 4, 2020 (AU) 2020903185

(51) Int. Cl. B60L 5/24

(52) U.S. Cl. CPC B60L 5/24; B60L 53/14

(57) ABSTRACT

There is proposed a boom apparatus or boom head assembly being attachable to an electric or hybrid vehicle. The boom apparatus, comprising first and second poles being alignable with the respective wires of an overhead power line system, and respective boom head assemblies coupled to the first and second poles, including a collector configured to abut the first wire. The boom head assemblies each including a respective movable guide, comprising opposing wings that are positioned on either side of a respective collector, being configured to aid in the alignment of the collector with a respective wire. The connecting pole assembly, together with the connecting pole stowage mechanism applies equally to a single wire catenary and connecting pole application as would be the case of a conventional tram.

### FIELD OF THE INVENTION

The present invention relates to a boom head assembly for a pole of an electric or hybrid vehicle, such as a trolley bus, for use with an overhead power line system.

### BACKGROUND OF THE INVENTION

Trolley buses are a non-rail electrically driven bus that typically draws power from dual overhead wires using spring-loaded trolley poles. This type of transport has been used throughout the world since around 1926.

The vehicle draws power from dual overhead wires that are suspended above the road surface and supported by traction poles. Typically, this is accomplished by way of spring-balanced trolley poles or booms. Two trolley poles are used to complete the electrical circuit via the two wires. Modern trolley buses may also incorporate banks of rechargeable batteries and/or an internal combustion engine for use when the vehicle is disconnected from the overhead wires.

There are various configurations of couplings used to connect the trolley poles to the overhead wires. One such boom head is disclosed in U.S. Pat. No. 4,742,185 to Delachaux S.A., which comprises a trolley bus head including a cradle configuration to receive a replaceable wiper for transmitting electrical current to a cable carried within the trolley pole. The cradle swivel of Delachaux S.A., is pivotally mounted at the end of the trolley pole and the cradle is mounted thereon by means of a connection which allows it to oscillate about a substantially vertical axis and to rock about a substantially horizontal axis. The cradle holds the replaceable wiper for transmitting electric current to the cable carried on the trolley pole, by way of a shunt connected to the cradle. However, the moving portion of the cradle must be latched against the main body which can lead to issues in relation to coupling and uncoupling the head from the overhead wires.

Other patents that disclose different boom head configurations are German Patent No. DE3065621 (Clerc), for an automatic wire-engaging device for an electrical vehicle of the trolleybus type, and European Patent Application No. EP3269582 (Buhs et al), for a non-rail vehicle.

Some of the limitation with existing coupling devices is their difficult in coupling or uncoupling from overhead wires, and the difficulty of maintaining connection or alignment of the wire and wiper/collector.

It should be appreciated that any discussion of the prior art throughout the specification is included solely for the purpose of providing a context for the present invention and should in no way be considered as an admission that such prior art was widely known or formed part of the common general knowledge in the field as it existed before the priority date of the application.

The reader should appreciate that the terms “boom” and “pole” used in relation to the apparatus are used interchangeably to refer to the elongate members attached to the roof of the vehicle to which the boom head assemblies are attached.

### SUMMARY OF THE INVENTION

It is an object of the present invention to provide a boom head assembly with movable guide for an electric vehicle. Further objects of the present invention are to overcome at least some of the aforementioned problems, or at least provide the public with a useful alternative. The foregoing objects should not necessarily be considered as cumulative and various aspects of the invention may fulfil one or more of the above objects.

The invention could be broadly understood to comprise a boom apparatus for an electric vehicle, having a movable guide for assisting in engagement or alignment of a collector of the boom apparatus and an overhead line system.

In one aspect of the invention, but not necessarily the broadest or only aspect, there is proposed a boom head assembly for an electric vehicle, comprising:
a housing attachable to a pole of, or attached to, the electric vehicle;
a collector configured to abut an electrical wire of an overhead line system;
a movable guide positioned adjacent the collector, configured to aid in the alignment of the collector with the overhead wire; and an actuator for moving the movable guide relative to the housing.
   For a non-rail configured electric vehicle the overhead line system includes two wires, wherein two poles with respective boom heads, are attached or attachable to the electric/hybrid vehicle.

The poles may be attached to a main platform mountable to the roof of the vehicle. Preferably, the poles are pivotably connected to the first platform and biased upwardly therefrom, by way of a spring assisted biasing member or members. Cables may extend between a second platform and a cable attachment member on a respective pole. The cables preferably limits the extent to which the poles can be pivoted upwardly under the influence of the biasing member or members.

The first platform may include a boom pivot comprising a mount. A lower boom housing, comprising a first and second part, may be pivotably connected to the mount. Two springs may be positioned on either side of the lower boom housing and extend between the mount and the lower boom housing to apply upward pressure at the connecting point.

The electric vehicle may include an electrical storage unit, in one form being a bank or banks of rechargeable batteries.

The electric vehicle is intended to be a non-rail trolley bus, having either a single deck or double decks, however the vehicle may also be a train, tram or electric vehicle for use on a guided busway.

In another aspect of the invention there is proposed a boom apparatus for an electric or hybrid vehicle, comprising:
at least one pole being alignable with a wire of an overhead power line system;
at least one boom head assembly coupled to the at least one pole, and including a collector configured to abut said wire; and
a movable guide positioned adjacent the collector, the movable guide being configured to aid in the alignment of said collector with said wire of the overhead power line system.

The movable guide may comprise at least one movable wing, which is position to a side or sides of the overhead wire. Preferably, the guide comprises two wings, one positioned to facilitate engagement on each side of the overhead wire.

The housing may include two portions that engage and are attached to the free end of the pole. The two portions may be held together by bolts and co-operating nut, screws, or other fixing means.

The actuator in one form may include: an actuator body, actuator shaft and a rack gear. The rack gear being engageable with the actuator shaft in communication with the movable guide. The actuator body may be attached to, or form part of, the housing, the actuator serrated activating armature, the rack gear, links to the splined operating shaft attached to the rotating wing appendages on the head. Accordingly, the actuator shaft may be configured to move the rack gear, which acts on the respective pinion to thereby move the two wings relative to the housing.

Alternatively, a lever arm may be attached to the actuator shaft and configured to move the two wings between the lowered and raised positions.

Preferably, the two wings are movable between a raised position, wherein the wings extend upward, being spaced apart from the sides of the collector, such that the wings act as a guide for alignment of the collector with the overhead wire and a lowered position whereby the wings are vertically below the collector.

In one form the wings are rotated from the raised position, wherein they extend above the collector, into the retracted position, when the collector comes into contact with the overhead wire. Preferably, movement of the wings into the retracted position is activated by an electric current passing through the connecting piece and into the vehicle below, via the boom mechanism. In one form, movement of the wings or other moveable guide mechanism may be by way of a solenoid or similar magnet based ‘wound’ armature that, when the electric current passes through it, changes its polarity thus drawing a central core through the actuator which acts on a lateral splined shaft or pinion, thereby in turn causing the wings to rotate down away from the cable.

In the present form, when the poles (booms) are retracted, the overhead current would cease to flow and the solenoid magnetic field would revert to a rest condition, within the actuator causing the pinion to rotate the wings back into the raised position ready for the next connection to be made.

Each wing may be generally elongated, having a first end being enlarged and including a central point aligning an axis of rotation, and a second end that is generally inwardly tapered with a curved tip. Each wing has a generally longitudinal axis that is generally perpendicular to the axis of rotation. The axis of rotation of one wing is coaxial with the axis of rotation of the adjacent wing.

In one form the two wings positioned on either side of the collector are in a generally vertical orientation along their respective longitudinal axis, when in the raised position and are able to pivot into a position generally well below horizontal along their respective longitudinal axis when in the lowered position.

The collector is preferably fixed relative to the housing, however the collector may be mounted on a biasing member, wherein it may be configured to move relative to the housing to compensate for variations in the road surface.

Various seals and O-rings may be used to inhibit the ingress of rain, dust and/or debris.

The boom head assembly may be retrofitted to an existing trolley pole or a customised trolley pole may be used. The boom head assembly forms may form part of a boom apparatus that may be fitted to an electric/hybrid vehicle.

The boom head assembly may further include a retaining unit or clamp mounted at the rear of the roof of the vehicle to hold the boom when in the stowed position. The retaining unit in one form is a twin cam mechanism that is biased open by a biasing member or members, such that when the boom bears against parts of the twin cam mechanism it is caused to move against the bias of biasing member/s such that it captures the boom therebetween. A locking device may be used to hold the twin cam mechanism against the bias of the biasing member/s to thereby retain the boom in the stored position. An alternative fixed sided plus single cam assembly may provide an alternative stowage mechanism structure.

The biasing member/s may be helical spring/s, alternatively they may be tension, torsion or leaf springs.

In another aspect of the invention there is a proposed complete retrofit boom apparatus which would be attachable to a vehicle. This would comprise a forward platform assembly to accommodate the connecting pole assembly complete with the winged collection head attachment.

The second platform would support the rear assembly accommodating the pole stowage and winch mechanisms to fully facilitate automatic, non-manual intervention connection and disconnection from the overhead power cables and the In Motion Charging facility provided.

Electronic and or laser speed and distance technology may be used to control the connecting poles ascent process through the winch mechanism and may be incorporated in the retrofit platform.

In one form the boom apparatus may be retrofitted to an existing vehicle and be coupled to the vehicle's electrical drive/charging system. The boom apparatus may be configured to be attached to existing trolley bus fittings. The forward platform and rear platform may be supported by a number of fixing brackets which may be attached to the roof of the vehicle at points on either side of the roof structure with the retrofit boom apparatus bolted on top thereof.

In another aspect of the invention there is proposed a method of operating an electric vehicle, including the steps of:
providing a boom head assembly, comprising a housing, a collector, a movable guide positioned adjacent the collector and an actuator;
attaching the boom head assembly to a pole attached to the electric vehicle;
modifying the connecting pole such that the collector contacts an electrical wire of an overhead line system (catenary), wherein the guide assists in alignment of the collector and electrical wire; operating the actuator to move the guide into a lowered position wherein it is positioned below the collector; operating the electric vehicle whilst also incorporating a means of disengaging the collector from the electrical wire; and operating the actuator to move the guide into a raised position wherein it extends above and to at least one side of the collector.

In still another aspect of the invention there is proposed a boom apparatus or boom head assembly in accordance with any of the above aspects that can be retrofitted to an existing vehicle capable of electrical operation for example hybrid and battery powered vehicles or a modified internal combustion engine powered vehicle.

### BRIEF DESCRIPTION OF THE DRAWINGS

The accompanying drawings, which are incorporated in and constitute a part of this specification, illustrate an implementation of the invention and, together with the description and claims, serve to explain the advantages and principles of the invention. In the drawings,

FIG. 1 is a perspective view of a boom apparatus attached to an electric/hybrid vehicle;

FIG. 2 is a side view of the vehicle of FIG. 1, with the boom apparatus in a stowed position;

FIG. 3 is a perspective view of the boom apparatus mounting platform of FIG. 1;

FIG. 4 is an exploded view of the boom apparatus mounting platform of FIG. 3;

FIG. 5 is an exploded view of the boom head assembly of FIG. 1;

FIG. 6 is a partial view of the boom head assembly of FIG. 5, illustrating the wings in a raised position and the wire connecting to the catenary;

FIG. 7 is a rear view of the boom head assembly of FIG. 6;

FIG. 8 is a front view of the boom head assembly of FIG. 6, with the cable removed illustrating the groove of the collector;

FIG. 9 is a partial view of the boom apparatus illustrating the boom head assembly of FIG. 6, illustrating the wings in a lowered position and the wire abutting the collector;

FIG. 10 is a rear view of the boom head assembly of FIG. 9;

FIG. 11 is a front view of the boom head assembly of FIG. 9, with the cable removed;

FIG. 12 is a side schematic view illustrating the movement of the wings of the boom head assembly of FIG. 1;

FIG. 13 is a top view of the boom head assembly of FIG. 11;

FIG. 14 is a cross-sectional view through A-A of the boom head assembly of FIG. 13, illustrating the actuator having a rack and pinion configuration in the lowered (connected) position.

FIG. 15 is a top view of the boom head assembly of FIG. 14;

FIG. 16 is a cross-sectional view through B-B of the boom head assembly and wire of FIG. 15;

FIG. 17 is a top view of the boom head assembly of FIG. 6 in the lowered (connected) position

FIG. 18 is a cross-sectional view through C-C of the boom head assembly and wire of FIG. 17 as connection is imminent.

FIG. 19 is a cross-sectional view of an alternate embodiment including an actuator having a lever arm, illustrating the wings in a lowered position.

FIG. 20 is the cross-sectional view of FIG. 19, illustrating the wings in a raised position and indicating movement of the lever arm;

FIG. 21 is a perspective view of the retaining unit of FIG. 3 for capturing the boom, illustrating the cam mechanism in an open position;

FIG. 22 is a perspective view of the retaining unit of FIG. 21 being closed by the boom;

FIG. 23 is a perspective view of the retaining unit of FIG. 21 capturing the boom;

FIG. 24 is a perspective view of the retaining unit of FIG. 21 illustrating locking of the cam mechanism;

FIG. 25 is an end view of FIG. 21, illustrating the cams being biased into the open position;

FIG. 26 is an end view of FIG. 22, illustrating the closing of the cam mechanism;

FIG. 27 is an end view of FIG. 23, illustrating the capturing of the boom;

FIG. 28 is a side view of FIG. 27, with the boom captured by the retaining unit (spring mechanism being purely illustrative); and

FIG. 29 is a side view of FIG. 24, illustrating the locking of the cam mechanism.

### DETAILED DESCRIPTION OF THE ILLUSTRATED AND EXEMPLIFIED EMBODIMENTS

Similar reference characters indicate corresponding parts throughout the drawings. Dimensions of certain parts shown in the drawings may have been modified and/or exaggerated for the purposes of clarity or illustration.

Referring to the drawings for a more detailed description, there is illustrated a boom head assembly 10, demonstrating by way of examples, arrangements in which the principles of the present invention may be employed.

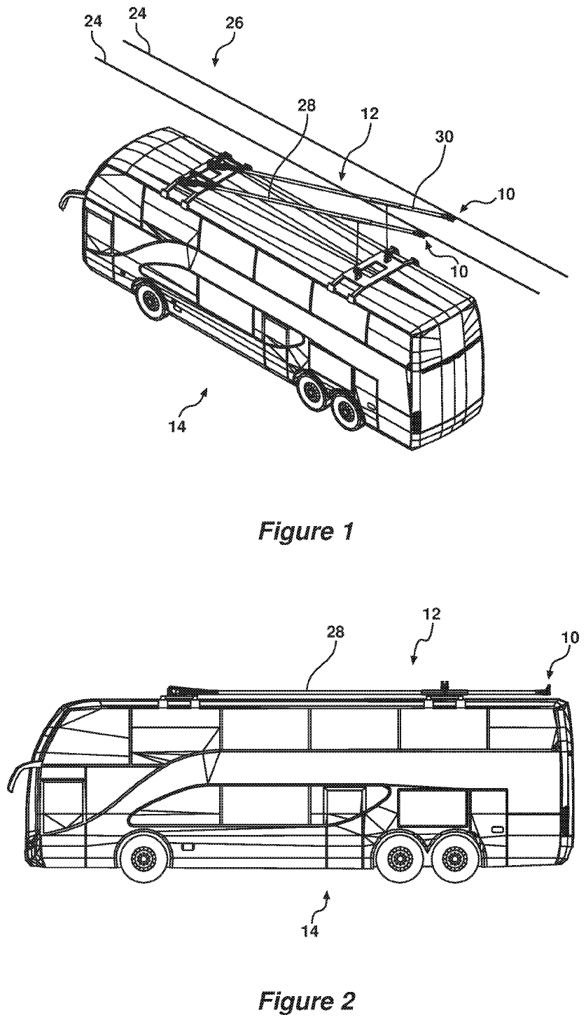

FIG. 1 illustrates a boom apparatus 12 incorporating the boom head assembly 10, which can be retrofitted to an electric vehicle, in the present example being a hybrid or battery powered vehicle 14. The reader will appreciate that the boom head assembly may be incorporated into new electric vehicles or may be attached to boom apparatus of different configurations than those illustrated.

The boom head assembly 10, includes a movable guide unit 16, in the form of opposing wings 18, 20, which are configured to align the contact 22 and a wire 24 of an overhead power line system (the catenary) 26.

As further illustrated in FIG. 1, the boom apparatus 12, includes two poles 28, 30 (also referred to as booms), having respective boom head assemblies 10 attached thereto.

As the reader will appreciate, the boom apparatus 12 can be lowered, as illustrated in FIG. 2, wherein the trolley bus 14 can be operated independent of the overhead line system 26, by way of a battery or conventional engine. The reader will appreciate that the invention can be used on a hybrid diesel powered vehicle, hybrid petrol powered vehicle or battery/electric vehicle.

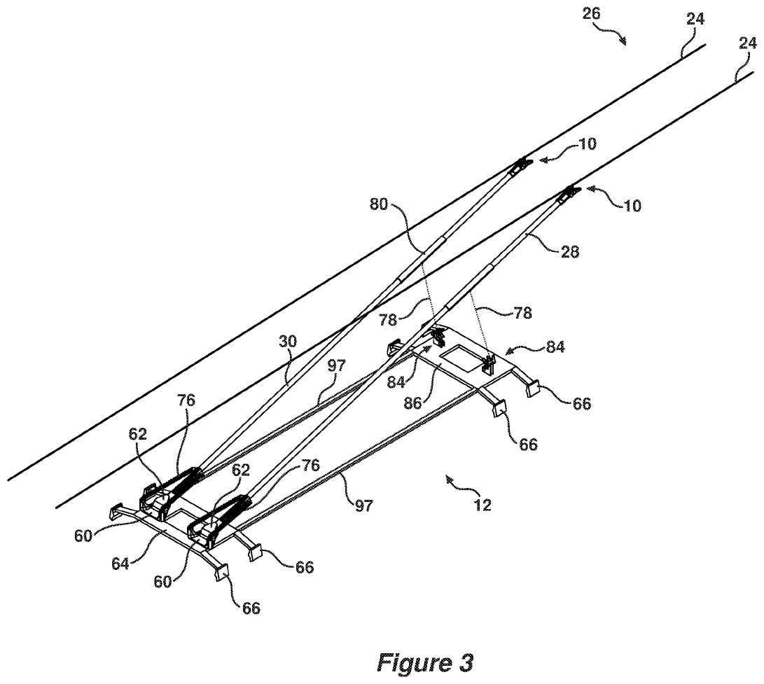

FIGS. 3 to 5 illustrate the components of the boom apparatus 12 and boom head assembly 10, which can be retrofitted to the trolley bus 14. The reader should however appreciate that the boom apparatus 12 and/or boom head assembly 10 can be incorporated into a vehicle itself and form an integral part thereof.

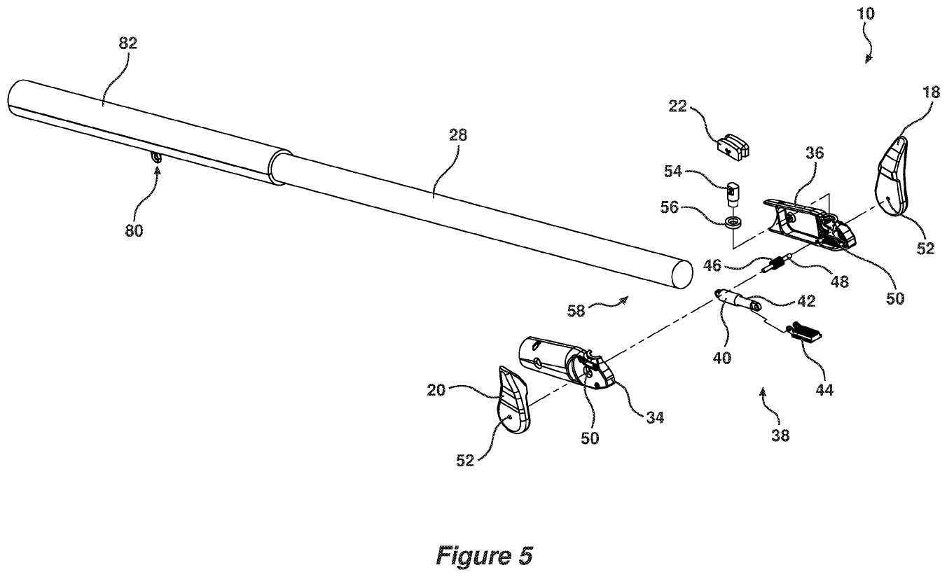

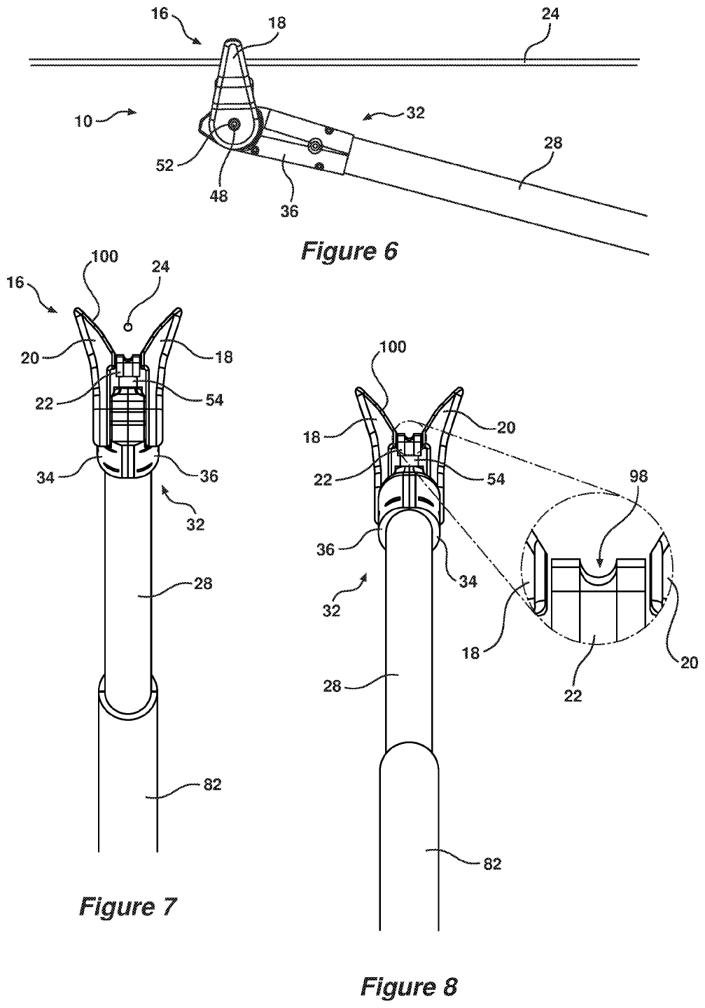

As shown in FIG. 5, the boom head assembly 10 includes wings 18, 20, the collector 22, a housing 32, comprising co-operating housing portions 34, 36.

The boom head assembly 10 further includes an actuator 38, which comprises an actuator body 40, actuator shaft 42 and a rack gear 44. The rack gear 44 is configured to engage a pinion 46 or rod 48. The rod 48 passes through holes in the housing portions 34, 36 and is fixedly attached through mounting apertures 52 in the wings 18, 20. The collector 22 is mounted to collector shaft 54 having bearing 56.

The housing 32, is configured to engage over the free end 58 of a respective pole 28 or 30.

The collector 22 is configured to abut the overhead electrical wire 24 in use and the movable guide 16, which is positioned adjacent the collector 22, is configured to assist in alignment of the collector 22 with the wire 24. The actuator 38 is configured to move the movable guide 16 relative to the housing, between a raised position and a lowered position, as will be discussed below.

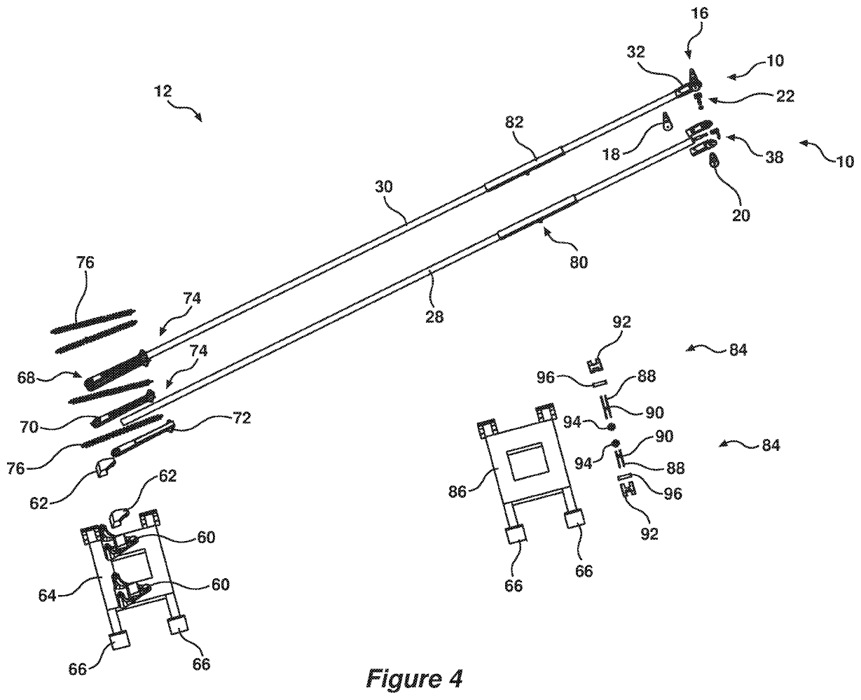

Turning back to FIGS. 3 and 4, the boom apparatus 12, includes a boom pivot 60 and boom pivot top 62, mounted to a platform 64 having clamp fixings 66. A lower boom housing 68, comprising co-operating parts 70, 72, are coupled to the lower end 74 of the poles/booms 28, 30, and are pivotably mounted to boom pivot Main springs 76 extend between the lower boom housing 68 and boom pivot 60.

A cable 78 extends between a cable attachment member 80 attached to a sleeve 82 on the pole 28 or pole 30, and a cable retraction device 84 mounted to a platform 86 having respective clamp fixings 66. Each cable retraction device 84, comprises a cable pull plate 88, a cable pull guide 90, a locking assembly 92, a pulley/pin assembly 94 and main pin 96.

The forward and rear mounting platforms 64 and 86 for the boom mechanism and retaining mechanism are connected by way of struts 97 to provide a counterbalance on the roof mounting of the vehicle to the upward pressure of the connecting poles 28, 30, as illustrated in FIG. 3. The platform 28 and/or 30 also provides for the operating electrics to be connected as a complete unit when attached to the vehicle.

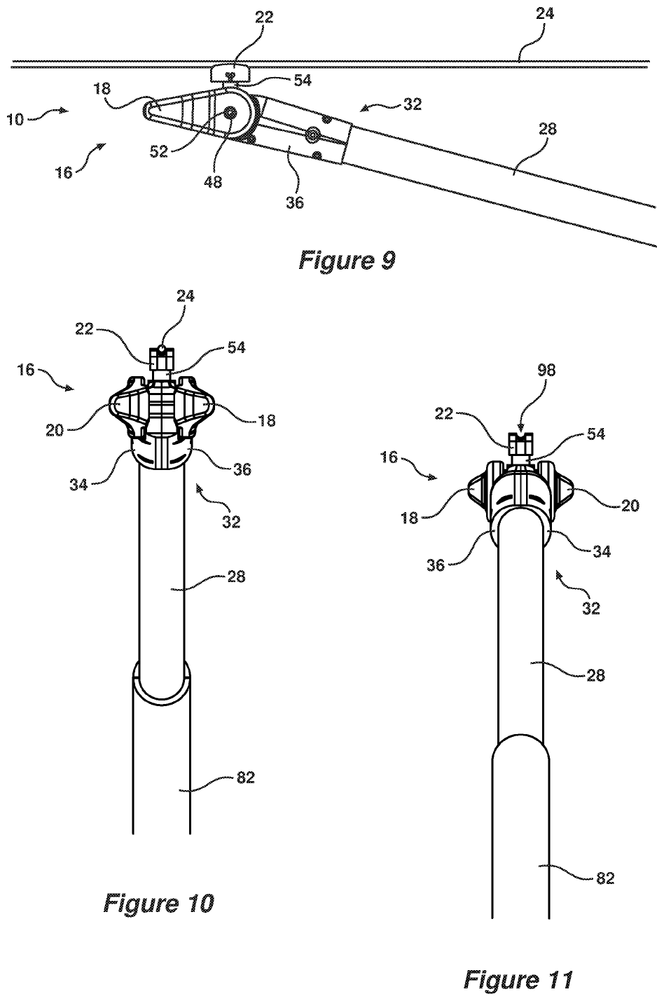

As illustrated in FIG. 3, the two cables 78 are used to control the angle to which the poles 28 and 30 are traversed upward by the springs 76. In this way the poles 28 and 30 can be pivoted upwardly until the collector 22 contacts the overhead wires 24, as illustrated in FIGS. 9 and 10.

The upper surface of the collector 22 includes a longitudinal groove 98 for accommodating the wire 24, as illustrated in FIGS. 8, 11 and 13. In this way the wings 18 and 20 act a guide to align or position the wire 24 and collector 22, such that the wire 24 is captured within the groove 98 to slide freely. As the reader will appreciate, if the wire moves to a side of the collector 22, the curved inner faces 100 of the opposing wings 18, 20 tend to force the wire 24 back towardly a mid-point where it will come back into contact with the collector 22, such that is it held within the groove 98.

Once in position the wings 18 and 20 can be rotated downwardly so that they are positioned generally below the horizontal plane of the wire 24 and on sides thereof, as illustrated in FIGS. 9 and 10.

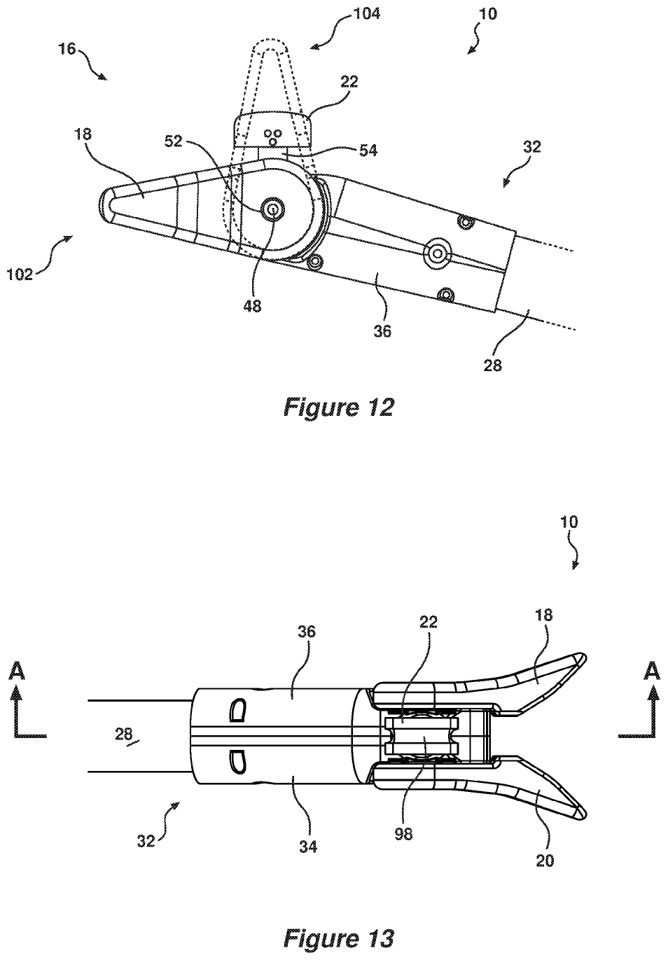

The wings 18, 20 of the present embodiment, are pivotable between a lowered position 102 and a raised position 104, as illustrated in FIG. 12. In the lowered position 102 the wings 18, 20 are arranged in a generally horizontal orientation along their respective longitudinal axis, and when in the raised position are arranged in a generally vertical orientation along their respective longitudinal axis. The skilled address will however appreciate that the orientation may be varied and does not necessarily have to be horizontal or vertical depending upon the shape of the wings. Further it should be appreciated that the wings or guide may be moved upwardly along a generally vertical axis such that they slide upwardly, or the wings may swing upwardly in an arc and be hinged at a rear edge thereof.

The reader should appreciate that although two wings, are coupled together, are illustrated in the embodiments, the guide may be a unitary generally U-shaped or V-shaped member.

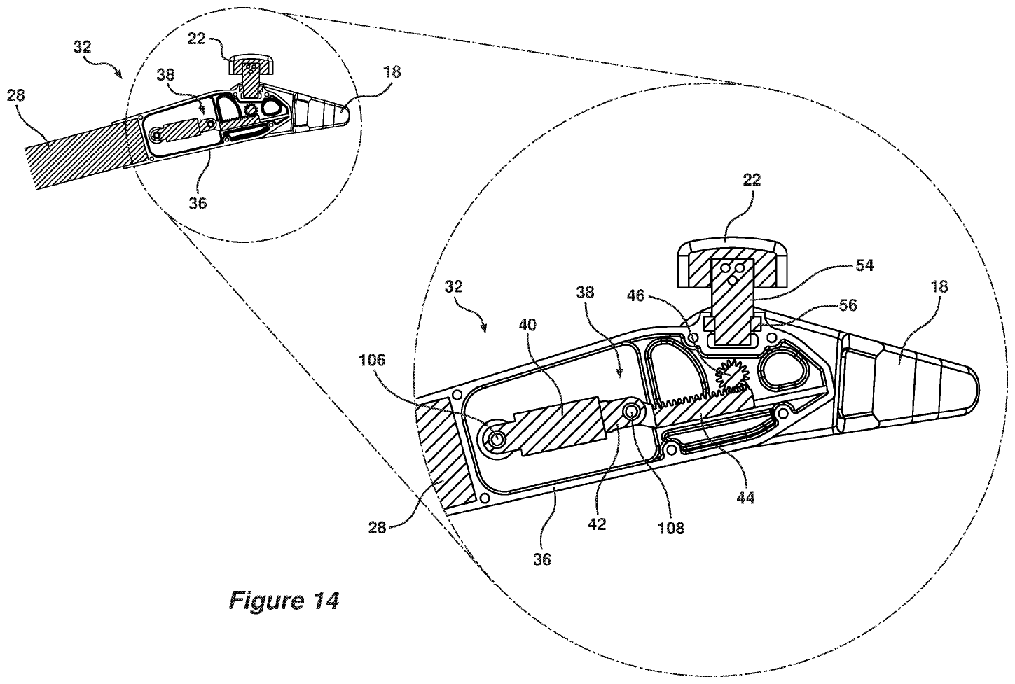

As illustrated in FIG. 14, the actuator body 40 is attached to the housing 32 by fixing member 106, and the actuator shaft 42 slidably engages the actuator body 42. The actuator shaft 42 is attached to the rack gear 44 by attachment member 108. Accordingly, the actuator shaft 42 is configured to move the rack gear 44, which acts on the pinion 46 to thereby move the wings 18, 20 relative to the housing 32 between the lowered and raised positions.

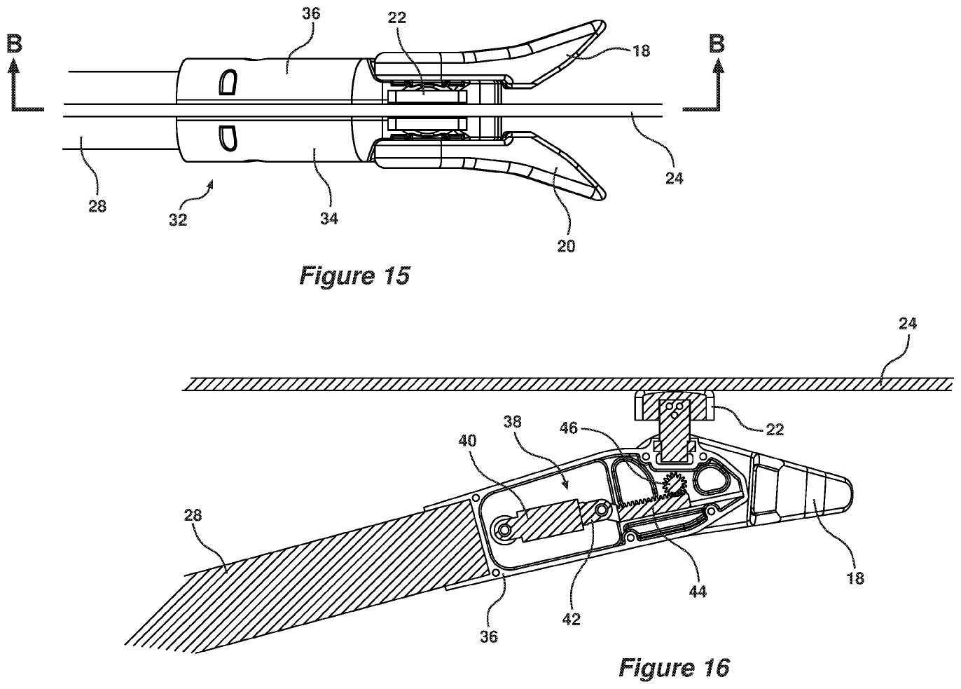

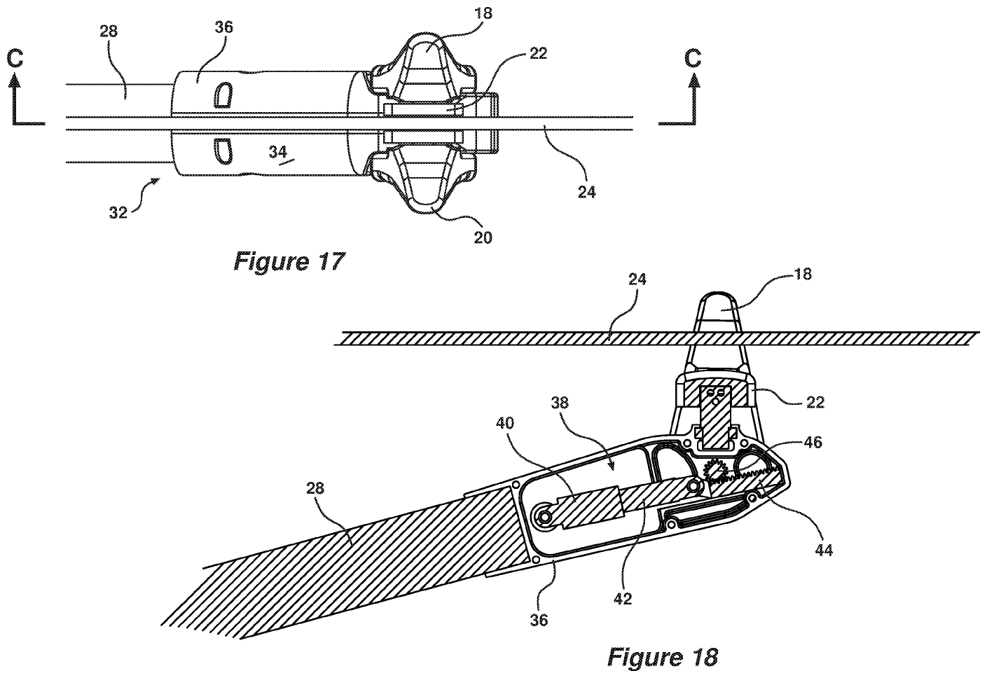

FIGS. 15 and 16, illustrate the position of the actuator 38, when the collector 22 is in contact with the wire 24 and the wings 18, 20 are in the lowered position. When pole 28 is lowered and the wire 24 disengages from the collector 22, the actuator shaft 42 is moved outward from within the actuator body 42 thereby moving the rack gear 44 forward. This rotates the pinion 46 on the rod 48, thereby rotating the wings 18, 20 into a raised position, as illustrated in FIGS. 17 and 18. The reader will now appreciate that the wings 18, 20 assist in aligning the wire 24 and collector 22 during coupling of the boom head assembly 10 to the overhead power line system 26.

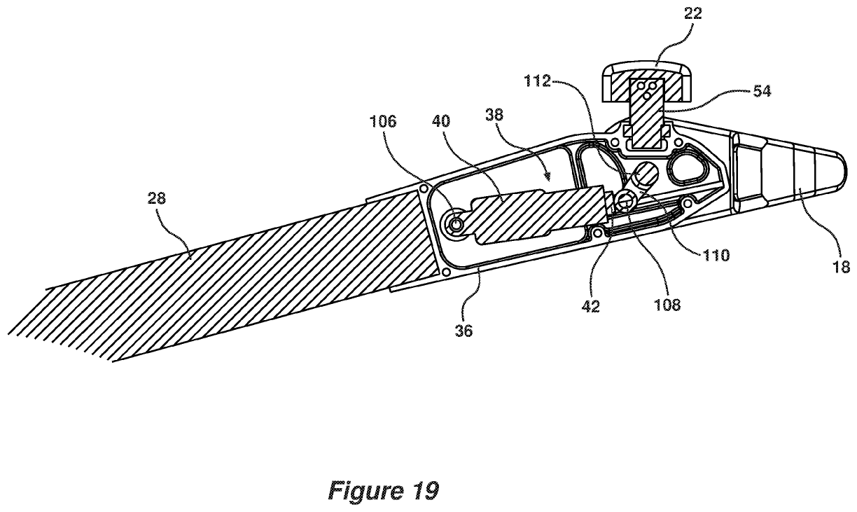

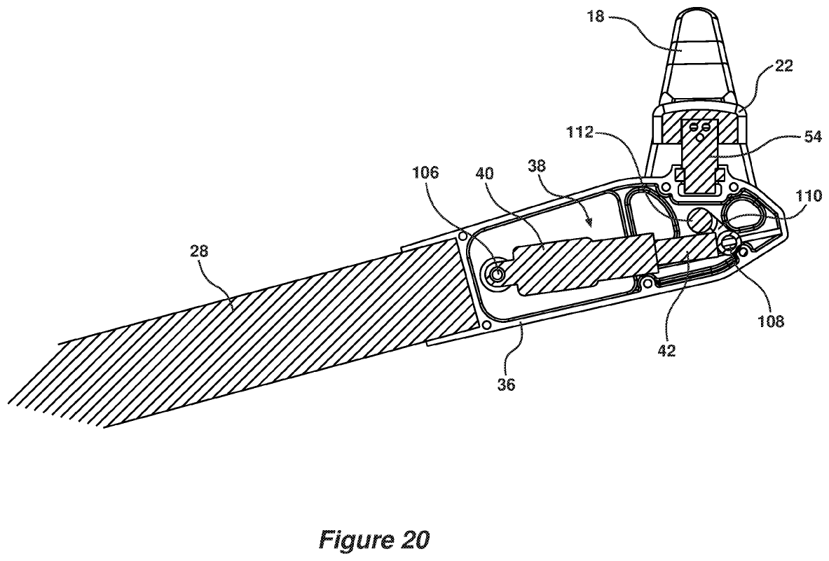

Alternatively, as illustrated in FIGS. 19 and 20, the actuator 38 may include a lever arm 110 attached to a rod 112, which is coupled to the wings 18, 20. The lever arm 110 is configured to rotate about attachment member 108 and the fixing member 106 may also move to a degree relative to the housing 32. The lever arm 110 is configured to act in a similar fashion to the rack and pinion assembly to move the wings 18, 20 between the lowered and raised positions.

The reader will now appreciate that the boom head assembly 10, which could also be called a connecting unit is attachable to the top end of the poles 18, 20 of the overhead power boom assembly. The rotating wings may be activated by an electric current passing through a connecting piece and into the vehicle below via the boom mechanism. Movement of the wings 18, 20, or other moveable guide 16, may be by way of a solenoid or similar magnet based ‘wound’ armature such that when the system DC current passes through it, which changes its polarity drawing a central core through an activating unit to act on a lateral splined shaft that in turn causes the twin outside wings 18, 20 to rotate down away from the cable.

When the poles 28, 30 are retracted from the overhead wire the current would cease and the solenoid magnetic field would revert to rest configuration. The armature would then activate the splined shaft thus bringing the wings 18, 20 back up into the raised position, as illustrated in FIG. 2.

A capacitor mechanism may be incorporated to ensure that on the disconnection of the boom head assembly from the power wire 24, a two to three second delay would occur before the head units regained the raised position. This is to accommodate power breaks in normal operation on overhead cable crossovers and junctions where a break in current can occur.

The reader will appreciate that many of the electrical components of the assembly, vehicle and battery bank will not be described since they would be obvious to a person skilled in the art.

The apparatus may also include a retaining unit 114 mounted at the rear of the roof of the bus 14. Accordingly, when the winch mechanism is operated to retract the pole 28, 30 into a stowed position the pole or boom itself would be captured within a twin hook clamp mechanism, which would close over the respective booms 28, 30 sufficient to retain them, and simultaneously switching off the winch mechanism.

When the deployment of the poles or booms 28, 30 is required, the appropriate release/locking mechanism is operated by a solenoid armature, which would push up on the central pivot of the twin cam mechanism pushing the base of the cam upwards and opening the jaws thus releasing the booms 28, 30 to enable them to connect with the overhead wires 24. Alternatively, the twin cam mechanism can be biased into the open position, wherein when the release/locking mechanism is operated the cams are moved by the bias to thereby release the pole or boom 28,

FIGS. 21 to 29, illustrate one embodiment of the retaining unit 114, for use with boom 28. The reader will appreciate that boom 30 would also have a respective retaining unit.

The retaining unit 114 includes a base 116 for attachment to a roof mounted platform 86 of the vehicle 14 adjacent the cable retraction devices 84 as shown FIG. 3. Cams 118, 120, are connected to the base 116 and pivotable about pivot point 122. Each cam 118, 120 includes an actuation portion 124 and cam hook 126. Biasing springs 128, are attached between the base 114 and respective cams 118, 120, such that the cams 118, 120 are biased into an open arrangement, as illustrated in FIG. 21.

The retaining unit 114 further includes a locking member 130, having a movable locking pin 132 that is configured to engage through hole 134, when the cams 118, 120 are in the closed position.

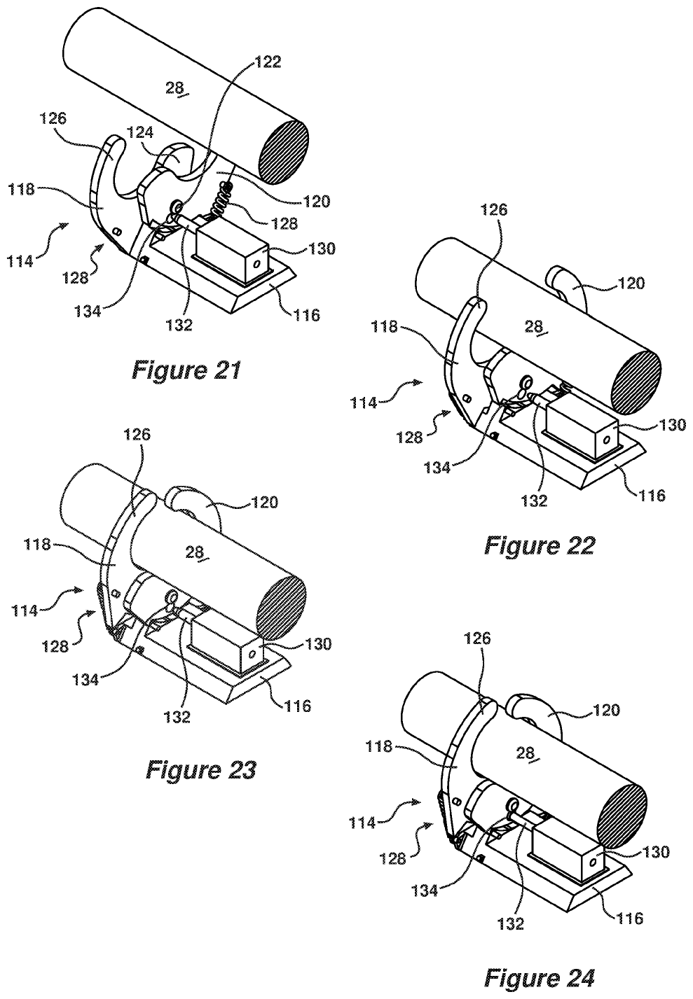

As illustrated in FIG. 22, when the boom 28 comes into contact with the actuation portions 124, the cams 118, 120 are caused to pivot about pivot point 122. As the boom 28 continues to bear down on the actuation portions 124, as illustrated in FIG. 23, the curved finger 126 captures the boom 28 therebetween.

The locking member 130 is then activated, as illustrated in FIG. 24, such that the locking pin 132 is moved into engagement through the hole 134 in the cam 118, to thereby hold the boom 28 in a stowed arrangement.

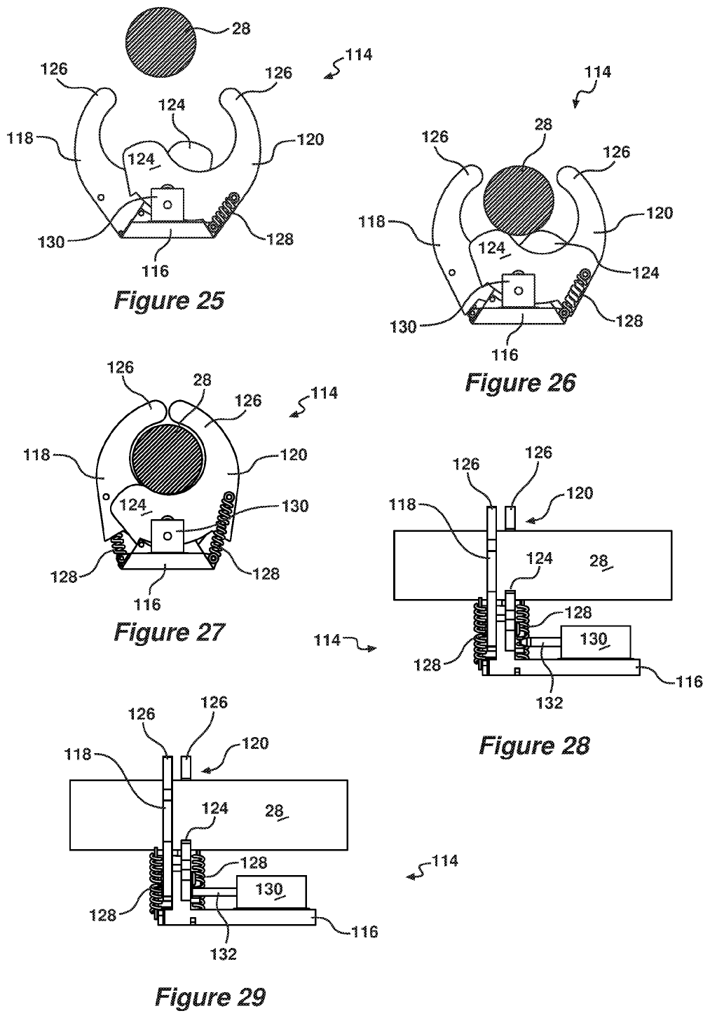

When the boom 28 is to be released the locking member 130 is operated such that the locking pin 132 is withdraw and the cams 118 and 120 are free to pivot under the influence of the biasing springs 128 or alternatively the boom assembly springs 76, into the open position, as shown in FIG. 21, to thereby release the boom 28. FIGS. 25 to 27 further illustrate the operation of the cams 118 and 120 when the boom 28 comes into contact with the actuation portions 124 of the cams 118, 120.

FIGS. 28 and 29 illustrate the operation of the locking member 130, wherein the locking pin 132 is movable between an unlocked position, as illustrated in FIG. 28, and a locking position wherein it engages hole 134, through the cam 118. The reader should appreciate that the locking pin may engage through both cams 118, 120 having respective holes 134.

The skilled addressee will now appreciate the advantages of the illustrated invention over the prior art. In one form, the invention provides a boom head assembly that can be retrofitted to existing trolley buses and can be used in conjunction with conventional overhead power line system (catenary). The illustrated invention also provides a system for automatically aligning the overhead wires and the collector. Furthermore, the illustrated invention extends to provide an automatically operated stowing device that secures the booms/poles in place when not in use. The invention provides a winged unit at the end of the pole (boom) to enables connection with the catenary power source which: a) provides power to the motor that drives the vehicle; and b) delivers the In Motion Charging electrical energy to the on-board batteries.

In another aspect of the invention, the hook units capture and stow the poles (booms) until required for use at which point the unit releases and deploys them. The winch mechanism is used to disconnect the two poles from the catenary and on deployment governs the speed thereof to avoid damage to the catenary.

Various features of the invention have been particularly shown and described in connection with the exemplified embodiments of the invention, however it must be understood that these particular arrangements merely illustrate the invention and it is not limited thereto. Accordingly, the invention can include various modifications, which fall within the spirit and scope of the invention. For the purpose of the specification the word “comprise”, “comprises” or “comprising” means “including but not limited to”.

1.-16. (canceled)

17. A boom apparatus for an electric or hybrid vehicle, comprising:
a first pole being alignable with a first wire of an overhead power line system;
a second pole being alignable with a second wire of the overhead power line system;
a first boom head assembly coupled to the first pole, and including a first collector configured to abut the first wire;
a second boom head assembly coupled to the second pole, and including a second collector configured to abut the second wire;
wherein the first and second boom head assemblies are configured to form an electrical circuit when engaging the respective wires of the overhead power line system;
wherein the first boom head assembly includes a first movable guide positioned adjacent the first collector, and the second boom head assembly includes a second movable guide positioned adjacent the second collector, the first and second movable guides being configured to aid in the alignment of the corresponding collector with the respective first wire or second wire simultaneously; and
wherein the first and second movable guides are configured to move simultaneously into a lowered position when said electrical circuit is formed by the first and second boom head assemblies engaging respective wires of the overhead power line system.

18. The boom apparatus in accordance with claim 17, wherein the first boom head assembly and second boom head assembly each include a respective actuator for moving the respective movable guide relative to a respective housing based on the engagement or disengagement of the first and second boom head assemblies with the positive or negative wires of the overhead power line system.

19. The boom apparatus in accordance with claim 18, wherein the respective actuator of each boom head assembly moves the respective movable guides into a lowered position when the circuit is formed by the first and second boom head assemblies engaging respective wires of the overhead power line system, and the respective movable guides are moved into a raised position when said circuit is broken or interrupted.

20. The boom apparatus in accordance with claim 17, wherein the first pole and second pole are pivotably connected to a main platform and biased upwardly therefrom, by way of a spring assisted biasing member or members for the two to operate in tandem.

21. The boom apparatus in accordance with claim 19, wherein each movable guide comprises two opposing wings, being positionable on opposite sides of a respective first wire or second wire and operated by electrical current flow within both head assemblies simultaneously.

22. The boom apparatus in accordance with claim 21, wherein the two opposing wings are positioned on either side of each respective collector, the opposing wings being generally elongate and movable between a lowered position wherein a longitudinal axis of the opposing wings are positioned generally vertically such that the opposing wings are substantially below a corresponding collector, and a raised position, wherein the opposing wings extend upwardly, and spaced apart from sides of the corresponding collector, such that the opposing wings provide guidance for alignment of the respective collector with the first wire or second wire, whereby current flow is achieved through both head assemblies simultaneously.

23. The boom apparatus in accordance with claim 19, wherein each actuator includes an actuator body, actuator shaft and a rack gear, the rack gear being engageable with the actuator shaft being in communication with a respective movable guide wherein the booms would be deployed to connect to the wires of the overhead power line system simultaneously in order to complete the electrical circuit to power the rotation of the pole head wing actuators.

24. The boom apparatus in accordance with claim 23, wherein movement of the opposing wings into the retracted position being activated by an electrical current passing through a connecting piece through the vehicle below thus completing the electrical circuit to activate the mechanisms.

25. The boom apparatus in accordance with claim 24, wherein movement of the opposing wings is by way of a solenoid or magnet based wound armature that, when the electrical current passes therethrough, changes its polarity thus drawing a central core through the actuator which acts on a lateral splined shaft or pinion, thereby in turn causing the opposing wings of both head assemblies to simultaneously rotate down to a position below the level of the wire.

26. The boom apparatus in accordance with claim 25, further including a super capacitor to provide electrical power in order to obviate the redeployment effects of any short duration cut in electrical supply as may be caused at a catenary junction crossing or other junction member.

27. The boom apparatus in accordance with claim 17, being retrofittable to an electric or hybrid vehicle.

28. A twin boom head assembly for a boom apparatus of an electric or hybrid vehicle, comprising:
a first housing attachable to a first connecting pole of, or attached to, the electric or hybrid vehicle;
a second housing attachable to a second connecting pole of, or attached to, the electric or hybrid vehicle;
the first housing and the second housing including a respective collector configured to abut a respective electrical wire of an overhead line system to thereby form an electrical circuit via the positive and negative electrical wires when the respective collectors are in engagement with the overhead power line system;
a respective movable guide positioned adjacent each of the respective collectors, configured to aid in the alignment of the collectors with respective electrical wires; and
an actuator or actuators for simultaneously moving said movable guides relative to the respective housings when said electrical circuit is formed.

29. The twin boom head assembly in accordance with claim 28, wherein a forward platform and interconnected rear platform is mountable to a roof of the electric or hybrid vehicle; and the first connecting pole and second connecting pole are pivotably attachable to the forward platform, and reversibly couplable to the rear platform.

30. The twin boom head assembly in accordance with claim 29, further including stowage units mounted to the rear platform and being configured to hold respective booms when in the stowed position following simultaneous boom disconnection from the positive and negative wires of the overhead power line system.

31. The twin boom head assembly in accordance with claim 30, wherein the stowage units each comprise a twin cam mechanism that is biased open by a biasing member or members, such that when the boom bears against parts of the twin cam mechanism it is caused to move against the bias of biasing member/s such that it captures the boom therebetween, and a locking device is configured to hold the twin cam mechanism against the bias of the biasing member/s to thereby retain the boom in the stowed position, wherein the twin connecting poles are configured to disconnected simultaneously.

32. A method of operating an electric or hybrid vehicle, including the steps of:
providing a boom head, comprising a housing, a collector, incorporating a movable guide positioned adjacent the collector and an actuator;
attaching respective boom heads to each of twin poles of the twin boom head assembly in accordance with claim 28;
attaching the twin boom head assembly to a roof of an electric or hybrid vehicle;
adjusting the twin poles such that the each collector of a respective boom head contacts a respective positive or negative electrical wire of an overhead power line system or catenary, to thereby form an electrical circuit, wherein the movable guides assist in alignment of the each collector and a respective electrical wire;
simultaneously operating the actuator or actuators to move the guides into a lowered position wherein they are positioned below the respective collector;
operating the electric or hybrid vehicle;
disengaging the collectors from the electrical wires; and
operating the actuator or actuators to move the guides into a raised position wherein they extend above each side of the respective collector.
